(19) United States
(12) Patent Application Publication
(10) Pub. No.: US 2024/0361679 A1
(43) Pub. Date: Oct. 31, 2024

(54) OPTICAL ENGINE MODULE AND PROJECTION DEVICE

(71) Applicant: Coretronic Corporation, Hsin-Chu (TW)

(72) Inventors: Chang-Hsuan Chen, Hsin-Chu (TW); Ming-Tsung Weng, Hsin-Chu (TW)

(73) Assignee: Coretronic Corporation, Hsin-Chu (TW)

(21) Appl. No.: 18/646,775

(22) Filed: Apr. 26, 2024

(30) Foreign Application Priority Data
Apr. 28, 2023 (CN) 202310478416.3

(51) Int. Cl. G03B 21/20

(52) U.S. Cl. CPC G03B 21/2066

(57) ABSTRACT

An optical engine module, configured to receive an illumination light beam, includes a light valve module, an optical prism, and a first connecting layer. The optical prism is disposed on a transmission path of the illumination light beam and configured to guide the illumination light beam to the light valve module and to guide an image light beam from the light valve module. The light valve module is disposed on the transmission path of the illumination light beam from the optical prism and configured to convert the illumination light beam into the image light beam. The first connecting layer is disposed between the light valve module and the optical prism. The image light beam from the light valve module sequentially passes through the first connecting layer and the optical prism to transmit in a direction. There is no air gap between the optical prism and the light valve module.

### CROSS-REFERENCE TO RELATED APPLICATION

This application claims the priority benefit of China application serial no. 202310478416.3, filed on Apr. 28, 2023. The entirety of the above-mentioned patent application is hereby incorporated by reference herein and made a part of this specification.

### BACKGROUND

### Technical Field

The disclosure relates to an optical module and an electronic device, and in particular, to an optical engine module and a projection device.

### Description of Related Art

The projection device is a display device for producing large-scale images and has been continuously improving with the evolution and innovation of technology. The imaging principle of the projection device is to convert the illumination light beam generated by the illumination system into an image light beam through the light valve, and then project the image light beam to the projection target (such as a screen or a wall) through the projection lens to form a projection image. In the 4K projection device, an actuator is added between the total reflection prism and the projection lens to increase the resolution of the display image by shaking.

In the current optical engine system containing actuators, in order to absorb the invalid beams generated when the light valve is in the off state, an off-ray heatsink is added between the total reflection prism and the actuator so as to absorb the ineffective beams. However, when an off-ray heatsink is put in, the back focus will be increased (back focus is a distance from a light entrance of the projection lens to the light valve), and it will cost a lot of money to re-open the mold to manufacture a new lens before the heatsink may be used. If the off-ray heatsink is not put in, there will be a problem of light leakage at the edge.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an optical engine module and a projection device, which may still have enough space to configure an actuating module and a heat dissipation element under the framework where a projection lens with a short back focus is used.

Other purposes and advantages of the disclosure may be further understood from the technical features disclosed in the disclosure.

To achieve one or part or all of the above objectives or other objectives, the disclosure provides an optical engine module configured to receive an illumination light beam. The optical engine module includes a light valve module, an optical prism, and a first connecting layer. The optical prism is disposed on a transmission path of the illumination light beam and configured to guide the illumination light beam to the light valve module and to guide an image light beam from the light valve module. The light valve module is disposed on the transmission path of the illumination light beam from the optical prism and configured to convert the illumination light beam into the image light beam. The first connecting layer is disposed between the light valve module and the optical prism, and the image light beam from the light valve module sequentially passes through the first connecting layer and the optical prism to transmit in a direction. There is no air gap between the optical prism and the light valve module.

To achieve one or part or all of the above objectives or other objectives, the disclosure further provides a projection device, including an illumination system, an optical engine module, and a projection lens. The illumination system is configured to provide an illumination light beam. The optical engine module is disposed on a transmission path of the illumination light beam. The optical engine module includes a light valve module, an optical prism, and a first connecting layer. The optical prism is disposed on the transmission path of the illumination light beam and configured to guide the illumination light beam to the light valve module and to guide an image light beam from the light valve module. The light valve module is disposed on the transmission path of the illumination light beam from the optical prism and configured to convert the illumination light beam into the image light beam. The first connecting layer is disposed between the light valve module and the optical prism, and the image light beam from the light valve module sequentially passes through the first connecting layer and the optical prism to transmit toward the projection lens. There is no air gap between the optical prism and the light valve module. The projection lens is disposed on a transmission path of the image light beam and configured to project the image light beam out of the projection device.

Based on the above, the embodiments of the disclosure have at least one of the following advantages or functions. In the optical engine module and the projection device of the disclosure, the optical engine module includes the light valve module, the optical prism, and the first connecting layer. The first connecting layer is disposed between the light valve module and the optical prism, and the image light beam from the light valve module sequentially passes through the first connecting layer and the optical prism to transmit toward the projection lens in the projection device. There is no air gap between the optical prism and the light valve module. In this way, the distance from the light entrance of the projection lens to the light valve module may be reduced, and there is still enough space to configure the actuating module and the heat dissipation element under the framework where the projection lens with the short back focus is used.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projection device according to an embodiment of the disclosure.

FIG. 2 is a schematic diagram of an optical engine module and a projection lens according to an embodiment of the disclosure.

FIG. 3 is a schematic diagram of an optical engine module according to an embodiment of the disclosure.

FIG. 4 is a schematic diagram of an optical engine module according to another embodiment of the disclosure.

FIG. 5 is a schematic diagram of an optical engine module according to another embodiment of the disclosure.

FIG. 6 is a schematic diagram of an optical engine module according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

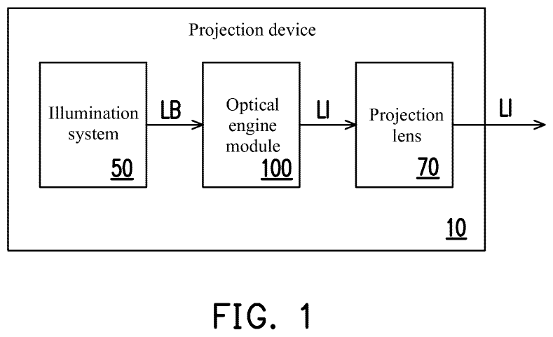

FIG. 1 is a schematic diagram of a projection device according to an embodiment of the disclosure. Please refer to FIG. 1. The embodiment provides a projection device 10 including an illumination system 50, an optical engine module 100, and a projection lens 70. The illumination system 50 is configured to provide an illumination light beam LB. The optical engine module 100 is disposed on a transmission path of the illumination light beam LB and configured to convert the illumination light beam LB into an image light beam LI. The projection lens 70 is disposed on a transmission path of the image light beam LI and configured to project the image light beam LI out of the projection device 10 to a projection target (not shown), such as a screen or a wall.

The illumination system 50 is used to provide the illumination light beam LB. For example, in the embodiment, the illumination system 50 is composed of multiple light emitting elements, wavelength conversion elements, uniform light elements, filter elements, and multiple light-splitting elements to provide light of different wavelengths, and the illumination light beam LB then forms the image light beam LI through the optical engine module 100. The multiple light emitting elements are, for example, light emitting diodes (LEDs) or laser diodes (LDs). However, the disclosure does not limit the type or form of the illumination system 50 in the projection device 10. The detailed structure and implementation thereof may be obtained from the sufficient teachings, suggestions, and implementation descriptions based on common knowledge in the technical field, and therefore the details are not repeated here.

The optical engine module 100 is, for example, composed of multiple prism elements, at least one light valve, and multiple different types of optical elements configured to receive the illumination light beam LB provided by the illumination system 50. The detailed implementations will be described later.

The projection lens 70 includes, for example, a combination of one or more optical lenses with diopters, such as various combinations of non-planar lenses such as biconcave lenses, biconvex lenses, concave-convex lenses, convex-concave lenses, plano-convex lenses, and plano-concave lenses. In an embodiment, the projection lens 70 may also include a planar optical lens to project the image light beam LI from the optical engine module 100 to the projection target in a reflective manner. The disclosure does not limit the type and form of the projection lens 70.

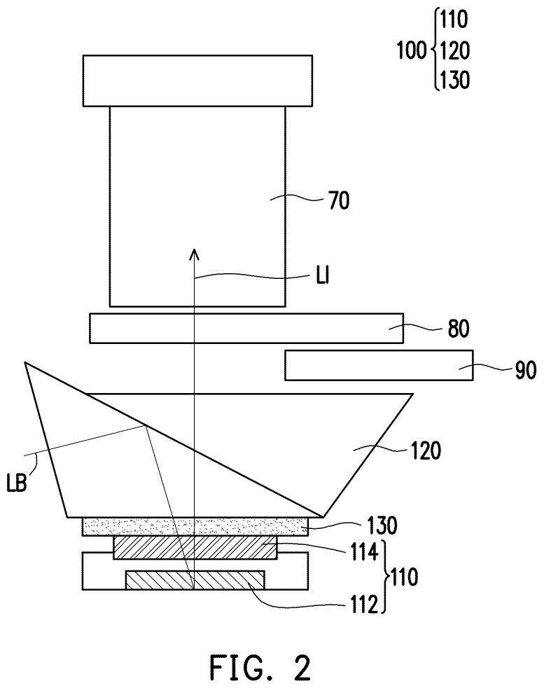

FIG. 2 is a schematic diagram of an optical engine module and a projection lens according to an embodiment of the disclosure. Please refer to FIG. 2. The optical engine module 100 and the projection lens 70 shown in the embodiment may be applied to at least the projection device 10 shown in FIG. 1. Therefore, the description below will take the projection device 10 shown in FIG. 1 as an example. In the embodiment, the projection device 10 further includes an actuating module 80 and a heat dissipation element 90. The actuating module 80 is, for example, an optical element and an actuator configured to drive the optical element. The actuating module 80 is disposed on the transmission path of the image light beam LI and located between the projection lens 70 and the optical engine module 100 to improve the resolution of the projection device 10. The heat dissipation element 90 is, for example, an off-ray heatsink configured to receive an off-axis ineffective light beam, which is disposed on a transmission path of the ineffective light beam (not shown) of the optical engine module 100 and does not block the image light beam LI transmitted toward the projection lens 70. The heat dissipation element 90 is located between the actuating module 80 and the optical engine module 100 to improve the resolution of the projection device 10 and receive the ineffective light beam.

The optical engine module 100 includes a light valve module 110, an optical prism 120, and a first connecting layer 130. The light valve module 110 is configured to convert the illumination light beam LB into the image light beam LI. The optical prism 120 is disposed on the transmission path of the illumination light beam LB and configured to guide the illumination light beam LB from the illumination system 50 to the light valve module 110 and to guide the image light beam LI from the light valve module 110. The optical prism 120 is, for example, a total internal reflection prism (TIR prism or RTIR prism).

The light valve module 110 is disposed on the transmission path of the illumination light beam LB from the optical prism 120. In the embodiment, the light valve module 110 includes a light valve element 112 and a protection cover plate 114. The protection cover plate 114 is disposed on the light valve element 112. The illumination light beam LB is incident on the light valve element 112 after passing through the protection cover plate 114. The light valve element 112 converts the illumination light beam LB into an image light beam LI. The image light beam LI is reflected to exit from the protection cover plate 114 and enter the optical prism 120. The first connecting layer 130 is configured between the protection cover plate 114 and the optical prism 120. In the embodiment, the light valve element 112 is, for example, a digital micro-mirror device (a DMD), or a reflective light modulator such as a liquid crystal on silicon panel (a LCoS panel). The disclosure does not limit the type and form of the light valve element 112. The detailed steps and implementation of the method for the light valve element 112 to convert the illumination light beam LB into the image light beam LI may be obtained from the sufficient teachings, suggestions, and implementation descriptions based on common knowledge in the technical field, and therefore the details are not repeated here. The protection cover plate 114 is, for example, a glass transparent plate and is configured to protect the light valve element 112 so as to prevent the light valve element 112 from contacting with external objects.

The first connecting layer 130 is disposed between the light valve module 110 and the optical prism 120. In the embodiment, the first connecting layer 130 is made of a material with a refractive index greater than 1.2, such as UV glue, or other kinds of glue with high temperature resistance and high light penetration properties. In the following embodiments, the components related to the connecting layer may be the glue as mentioned above. In detail, the configuration of the first connecting layer 130 is such that there is no air gap between the optical prism 120 and the light valve module 110. That is, the optical prism 120 and the protection cover plate 114 of the light valve module 110 are connected by the first connecting layer 130 so that there is no air gap between the optical prism 120 and the protection cover plate 114. Therefore, the image light beam LI from the light valve module 110 may sequentially pass through the first connecting layer 130 and the optical prism 120 to transmit along a direction (i.e., towards the projection lens 70). In addition, the first connecting layer 130 is disposed between the optical prism 120 and the light valve module 110 to fill the gap between the two, so that the unevenness of the surfaces of the optical prism 120 and the light valve module 110 may be eliminated to reduce the reflection or interference of the light passing between the interfaces. On the other hand, the first connecting layer 130 is disposed between the optical prism 120 and the light valve module 110 to effectively shorten the distance between the optical prism 120 and the light valve module 110. In this way, the distance from the light entrance of the projection lens 70 to the light valve module 110 may be reduced, and there is still enough space to configure the actuating module 80 and the heat dissipation element 90 under the framework where the projection lens 70 with the short back focus is used.

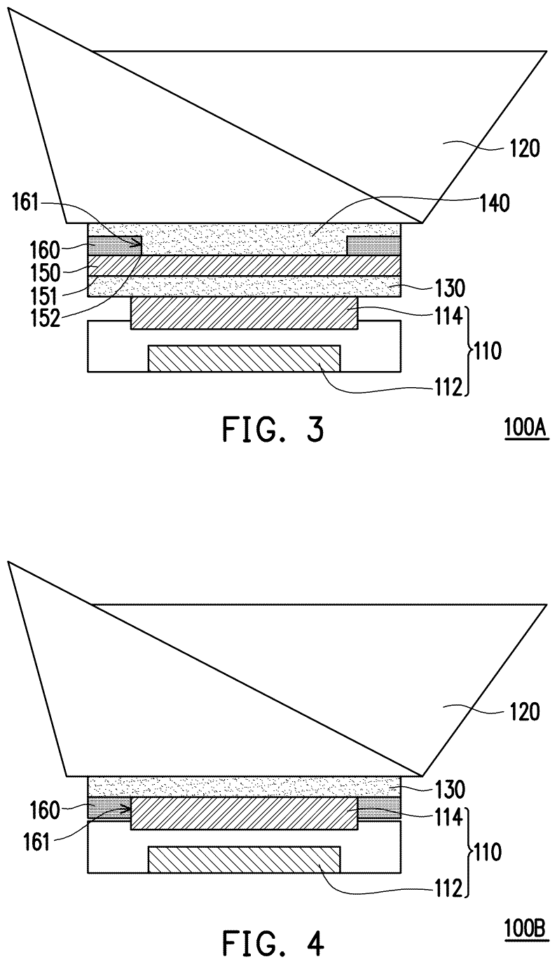

FIG. 3 is a schematic diagram of an optical engine module according to an embodiment of the disclosure. Please refer to FIG. 1 and FIG. 3 at the same time. An optical engine module 100A shown in the embodiment is similar to the optical engine module 100 shown in FIG. 2 and may at least replace the optical engine module 100 shown in FIG. 1. Therefore, the following description takes the optical engine module 100A of FIG. 3 replacing the optical engine module 100 of FIG. 1 as an example. The difference between the two is that, in the embodiment, the optical engine module 100A further includes a second connecting layer 140, a substrate 150, and a light shielding element 160. The substrate 150 and the light shielding element 160 are located between the first connecting layer 130 and the optical prism 120, and the substrate 150 is, for example, glass, but the disclosure is not limited thereto. The substrate 150 has a first surface 151 and a second surface 152. The first surface 151 faces the light valve element 112 and is connected to the first connecting layer 130. The light shielding element 160 has a through hole 161. The through hole 161 is, for example, a hole passing through the light shielding element 160. The light shielding element 160 is disposed on the second surface 152 of the substrate 150. For example, the light shielding element 160 is disposed around the second surface 152 to allow light to pass through the through hole 161 and to block divergent light. The material of the light shielding element 160 has a light-absorbing property or a reflective property, and the disclosure is not limited thereto.

A part of the second connecting layer 140 is located in the through hole 161 of the light shielding element 160 and connected between the substrate 150 and the optical prism 120. Another part of the second connecting layer 140 is connected between the light shielding element 160 and the optical prism 120. Specifically, the central part of the second connecting layer 140 is located in the through hole 161 of the light shielding element 160 and connected between the substrate 150 and the optical prism 120. That is, the through hole 161 of the light shielding element 160 is filled with the second connecting layer 140. The edge part of the second connecting layer 140 is connected between the light shielding element 160 and the optical prism 120. Similar to the first connecting layer 130, the second connecting layer 140 may be made of a material with a refractive index greater than 1.2, and the material may be the same as or different from the first connecting layer 130. In this way, the light shielding effect may be provided by the light shielding element 160, so that the optical quality may be improved, and at the same time, the distance from the light entrance of the projection lens 70 to the light valve module 110 may be reduced due to the connection between the elements through the connecting layer, so that there is still enough space to configure the actuating module 80 and the heat dissipation element 90 under the framework where the projection lens 70 with the short back focus is used.

FIG. 4 is a schematic diagram of an optical engine module according to another embodiment of the disclosure. Please refer to FIG. 1 and FIG. 4 at the same time. An optical engine module 100B shown in the embodiment is similar to the optical engine module 100 shown in FIG. 2 and may at least replace the optical engine module 100 shown in FIG. 1. Therefore, the following description takes the optical engine module 100B of FIG. 4 replacing the optical engine module 100 of FIG. 1 as an example. The difference between the two is that, in the embodiment, the optical engine module 100B further includes the light shielding element 160. The light shielding element 160 has the through hole 161. The light shielding element 160 surrounds the protection cover plate 114. That is, the protection cover plate 114 is partially disposed in the through hole 161. A part of the first connecting layer 130 is connected between the optical prism 120 and the protection cover plate 114. Another part of the first connecting layer 130 is connected between the optical prism 120 and the light shielding element 160. Specifically, in the embodiment, the central part of the first connecting layer 130 is connected between the optical prism 120 and the protection cover plate 114, and the edge part of the first connecting layer 130 is connected between the optical prism 120 and the light shielding element 160. In this way, the light shielding effect may be provided by the light shielding element 160, so that the optical quality may be improved, and at the same time, the distance from the light entrance of the projection lens 70 to the light valve module 110 may be reduced due to the connection between the elements through the connecting layer, so that there is still enough space to configure the actuating module 80 and the heat dissipation element 90 under the framework where the projection lens 70 with the short back focus is used. In addition, in the embodiment, the surface of the protection cover plate 114 facing the optical prism 120 and the surface of the light shielding element 160 facing the optical prism 120 are substantially coplanar. That is, the height difference between the surface of the protection cover plate 114 facing the optical prism 120 and the surface of the light shielding element 160 facing the optical prism 120 is within a certain range. The height difference is, for example, greater than or equal to 0 mm and less than or equal to 1 mm.

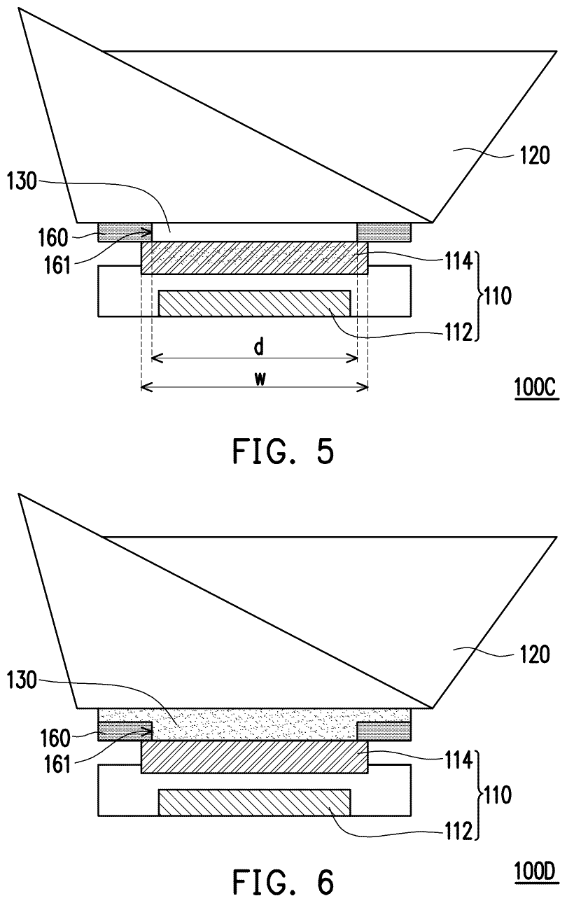

FIG. 5 is a schematic diagram of an optical engine module according to another embodiment of the disclosure. Please refer to FIG. 1 and FIG. 5 at the same time. An optical engine module 100C shown in the embodiment is similar to the optical engine module 100 shown in FIG. 2 and may at least replace the optical engine module 100 shown in FIG. 1. Therefore, the following description takes the optical engine module 100C of FIG. 5 replacing the optical engine module 100 of FIG. 1 as an example. The difference between the two is that, in the embodiment, the optical engine module 100C further includes the light shielding element 160. The light shielding element 160 has a through hole 161, and the light shielding element 160 is partially disposed on the surface of the protection cover plate 114 facing the optical prism 120. Specifically, a diameter d of the through hole 161 of the light shielding element 160 is smaller than a width W of the protection cover plate 114. Therefore, the inner edge of the light shielding element 160 adjacent to the through hole 161 is partially disposed on a part of the surface of the protection cover plate 114 facing the optical prism 120. The first connecting layer 130 is located in the through hole 161 (for example, fills the through hole 161) and connected between the optical prism 120 and the protection cover plate 114. In this way, the light shielding effect may be provided by the light shielding element 160, so that the optical quality may be improved, and at the same time, the distance from the light entrance of the projection lens 70 to the light valve module 110 may be reduced due to the connection between the elements through the connecting layer, so that there is still enough space to configure the actuating module 80 and the heat dissipation element 90 under the framework where the projection lens 70 with the short back focus is used.

FIG. 6 is a schematic diagram of an optical engine module according to another embodiment of the disclosure. Please refer to FIG. 1 and FIG. 6 at the same time. An optical engine module 100D shown in the embodiment is similar to the optical engine module 100 shown in FIG. 2 and may at least replace the optical engine module 100 shown in FIG. 1. Therefore, the following description takes the optical engine module 100D of FIG. 6 replacing the optical engine module 100 of FIG. 1 as an example. The difference between the two is that, in the embodiment, the optical engine module 100D further includes the light shielding element 160. The light shielding element 160 has the through hole 161, and the light shielding element 160 is partially disposed on the surface of the protection cover plate 114 facing the optical prism 120. In addition, a part of the first connecting layer 130 is located in the through hole 161 of the light shielding element 160, and the part of the first connecting layer 130 is connected between the optical prism 120 and the protection cover plate 114. Another part of the first connecting layer 130 is connected between the optical prism 120 and the light shielding element 160. Specifically, the central part of the first connecting layer 130 is located in the through hole 161 of the light shielding element 160 and connected between the optical prism 120 and the protection cover plate 114, and the edge part of the first connecting layer 130 is connected between the optical prism 120 and the light shielding element 160. In this way, the light shielding effect may be provided by the light shielding element 160, so that the optical quality may be improved, and at the same time, the distance from the light entrance of the projection lens 70 to the light valve module 110 may be reduced due to the connection between the elements through the connecting layer, so that there is still enough space to configure the actuating module 80 and the heat dissipation element 90 under the framework where the projection lens 70 with the short back focus is used.

To sum up, in the optical engine module and the projection device of the disclosure, the optical engine module includes the light valve module, the optical prism, and the first connecting layer. The first connecting layer is disposed between the light valve module and the optical prism. The image light beam from the light valve module sequentially passes through the first connecting layer and the optical prism to transmit towards a direction of the projection lens in the projection device. There is no air gap between the optical prism and the light valve module. In this way, the distance from the light entrance of the projection lens to the light valve module may be reduced, and there is still enough space to configure the actuating module and heat dissipation element under the framework where the projection lens with the short back focus is used.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. An optical engine module, configured to receive an illumination light beam, wherein the optical engine module comprises a light valve module, an optical prism, and a first connecting layer,
the optical prism is disposed on a transmission path of the illumination light beam and configured to guide the illumination light beam to the light valve module and to guide an image light beam from the light valve module,
the light valve module is disposed on the transmission path of the illumination light beam from the optical prism and configured to convert the illumination light beam into the image light beam,
the first connecting layer is disposed between the light valve module and the optical prism, the image light beam from the light valve module sequentially passes through the first connecting layer and the optical prism to transmit in a direction, and there is no air gap between the optical lens and the light valve module.

2. The optical engine module according to claim 1, wherein the light valve module comprises a light valve element and a protection cover plate, the protection cover plate is disposed on the light valve element, and the first connecting layer is configured between the protection cover plate and the optical prism.

3. The optical engine module according to claim 2, further comprising a second connecting layer, a substrate, and a light shielding element, wherein
the substrate and the light shielding element are located between the first connecting layer and the optical prism, the substrate has a first surface and a second surface, the first surface is connected to the first connecting layer,
the light shielding element is disposed on the second surface of the substrate, the light shielding element has a through hole,
a part of the second connecting layer is located in the through hole and connected between the substrate and the optical prism, and another part of the second connecting layer is connected between the light shielding element and the optical prism.

4. The optical engine module according to claim 3, wherein a refractive index of the second connecting layer is greater than 1.2.

5. The optical engine module according to claim 2, further comprising a light shielding element, wherein
the light shielding element has a through hole, the light shielding element surrounds the protection cover plate,
a part of the first connecting layer is connected between the optical prism and the protection cover plate, and another part of the first connecting layer is connected between the optical prism and the light shielding element.

6. The optical engine module according to claim 5, wherein a surface of the protection cover plate facing the optical prism and a surface of the light shielding element facing the optical prism are coplanar.

7. The optical engine module according to claim 2, further comprising a light shielding element, wherein
the light shielding element has a through hole, the light shielding element is partially disposed on a surface of the protection cover plate facing the optical prism,
the first connecting layer is located in the through hole, and the first connecting layer is connected between the optical prism and the protection cover plate.

8. The optical engine module according to claim 2, further comprising a light shielding element, wherein
the light shielding element has a through hole, the light shielding element is partially disposed on a surface of the protection cover plate facing the optical prism,
a part of the first connecting layer is located in the through hole, the part of the first connecting layer is connected between the optical prism and the protection cover plate, and another part of the first connecting layer is connected between the optical prism and the light shielding element.

9. The optical engine module according to claim 1, wherein a refractive index of the first connecting layer is greater than 1.2.

10. A projection device, comprising an illumination system, an optical engine module, and a projection lens, wherein
the illumination system is configured to provide an illumination light beam,
the optical engine module is disposed on a transmission path of the illumination light beam, the optical engine module comprises a light valve module, an optical prism, and a first connecting layer,
the optical prism is disposed on the transmission path of the illumination light beam and configured to guide the illumination light beam to the light valve module and to guide an image light beam from the light valve module,
the light valve module is disposed on the transmission path of the illumination light beam from the optical prism and configured to convert the illumination light beam into the image light beam,
the first connecting layer is disposed between the light valve module and the optical prism, the image light beam from the light valve module sequentially passes through the first connecting layer and the optical prism to transmit in a direction of the projection lens, there is no air gap between the optical prism and the light valve module, and
the projection lens is disposed on a transmission path of the image light beam and configured to project the image light beam out of the projection device.

11. The projection device according to claim 10, wherein the light valve module comprises a light valve element and a protection cover plate, the protection cover plate is disposed on the light valve element, and the first connecting layer is configured between the protection cover plate and the optical prism.

12. The projection device according to claim 11, wherein the optical engine module further comprises a second connecting layer, a substrate, and a light shielding element,
the substrate and the light shielding element are located between the first connecting layer and the optical prism, the substrate has a first surface and a second surface, the first surface is connected to the first connecting layer,
the light shielding element is disposed on the second surface of the substrate, the light shielding element has a through hole,
a part of the second connecting layer is located in the through hole and connected between the substrate and the optical prism, and another part of the second connecting layer is connected between the light shielding element and the optical prism.

13. The projection device according to claim 12, wherein a refractive index of the second connecting layer is greater than 1.2.

14. The projection device according to claim 11, wherein the optical engine module further comprises a light shielding element,
the light shielding element has a through hole, the light shielding element surrounds the protection cover plate,
a part of the first connecting layer is connected between the optical prism and the protection cover plate, and another part of the first connecting layer is connected between the optical prism and the light shielding element.

15. The projection device according to claim 14, wherein a surface of the protection cover plate facing the optical prism and a surface of the light shielding element facing the optical prism are coplanar.

16. The projection device according to claim 11, wherein the optical engine module further comprises a light shielding element,
the light shielding element has a through hole, the light shielding element is partially disposed on a surface of the protection cover plate facing the optical prism,
the first connecting layer is located in the through hole, and the first connecting layer is connected between the optical prism and the protection cover plate.

17. The projection device according to claim 11, wherein the optical engine module further comprises a light shielding element,
the light shielding element has a through hole, the light shielding element is partially disposed on a surface of the protection cover plate facing the optical prism,
a part of the first connecting layer is located in the through hole, the part of the first connecting layer is connected between the optical prism and the protection cover plate, and another part of the first connecting layer is connected between the optical prism and the light shielding element.

18. The projection device according to claim 10, wherein a refractive index of the first connecting layer is greater than 1.2.
